(19) United States
(12) Patent Application Publication
(10) Pub. No.: US 2013/0047039 A1
(43) Pub. Date: Feb. 21, 2013

(54) SYSTEM AND METHOD FOR COMPUTER ANALYSIS

(71) Applicants: Mark MANES, Superior, CO (US); Jun LIU, Boulder, CO (US); David VANPEENE, Denver, CO (US); Brent MERIWETHER, Erie, CO (US); Kerry RODGERS, Aurora, CO (US)

(72) Inventors: Mark MANES, Superior, CO (US); Jun LIU, Boulder, CO (US); David VANPEENE, Denver, CO (US); Brent MERIWETHER, Erie, CO (US); Kerry RODGERS, Aurora, CO (US)

(73) Assignee: AVANQUEST SOFTWARE USA, INC., Westminster, CO (US)

(21) Appl. No.: 13/212,768

(22) Filed: Aug. 18, 2011

(51) Int. Cl. G06F 11/30

(52) U.S. Cl. 714/47.1; 714/E11.179

(57) ABSTRACT

Disclosed is a system and method for monitoring processes. The method includes the steps of monitoring at least one process in real time, collecting information on the at least one monitored process, analyzing the collected information in real time using at least one dynamic, updatable filter, identifying at least one triggering item or event matching at least one predetermined filter criterion, providing information regarding the at least one triggering item to an event processing engine for examination, and taking at least one action in real time in response to the identified triggering item or event. In certain embodiments, the method is implemented with a computer program product having a non-transitory computer readable medium having stored thereon computer executable instructions that when executed causes the computer to perform the method.

### FIELD

This subject matter relates to systems and methods for computer analysis.

### BACKGROUND

In the current technological environment, users demand increasingly higher computing performance, and demand computers that run an increasingly high number of applications. Increasing the number of applications running on a computer, however, slows computing performance. To balance these competing requirements, existing systems attempt to monitor computer performance and manage the number of applications running on a computer. These systems, however, are unable to provide an analysis in real time, and/or unable to provide real time recommendations for improving performance. These and other drawbacks are solved in the exemplary embodiments described below.

### SUMMARY

Disclosed is a system and method for monitoring processes in real time, including the steps of monitoring at least one process in real time, collecting information on the at least one monitored process, analyzing the collected information in real time using at least one dynamic, updatable filter, identifying at least one triggering item or event matching at least one predetermined filter criterion, providing information regarding the at least one triggering item to an event processing engine for examination, and taking at least one action in real time in response to the identified triggering item or event. In certain embodiments, the method is implemented with a computer program product having a non-transitory computer readable medium having stored thereon computer executable instructions that when executed causes the computer to perform the method.

In another exemplary embodiment, a method of improving system startup or shutdown performance includes the steps of monitoring a startup or shutdown duration and comparing it to a baseline startup or shutdown duration, identifying a change in startup or shutdown duration with respect to the baseline duration, identifying at least one reason why system startup or shutdown duration changed, displaying to a user the at least one reason for the change in startup or shutdown duration, and providing to the user in real time at least one recommendation for improving the startup or shutdown duration.

### BRIEF DESCRIPTION OF THE DRAWING

A description of the present subject matter including various embodiments thereof is presented with reference to the accompanying drawings, the description not meaning to be considered limiting in any matter, wherein:

FIG. 1 illustrates a exemplary embodiment of a system for computer analysis;

FIG. 2A illustrates an exemplary method of computer analysis;

FIG. 2B illustrates an exemplary method of data collection and storage;

FIG. 2C illustrates an exemplary method of data analysis;

FIG. 3 illustrates a exemplary embodiment of a system for improving startup and/or shutdown; and

FIG. 4 illustrates an exemplary method for startup and/or shutdown improvement.

Similar reference numerals and designators in the various figures refer to like elements.

### DETAILED DESCRIPTION

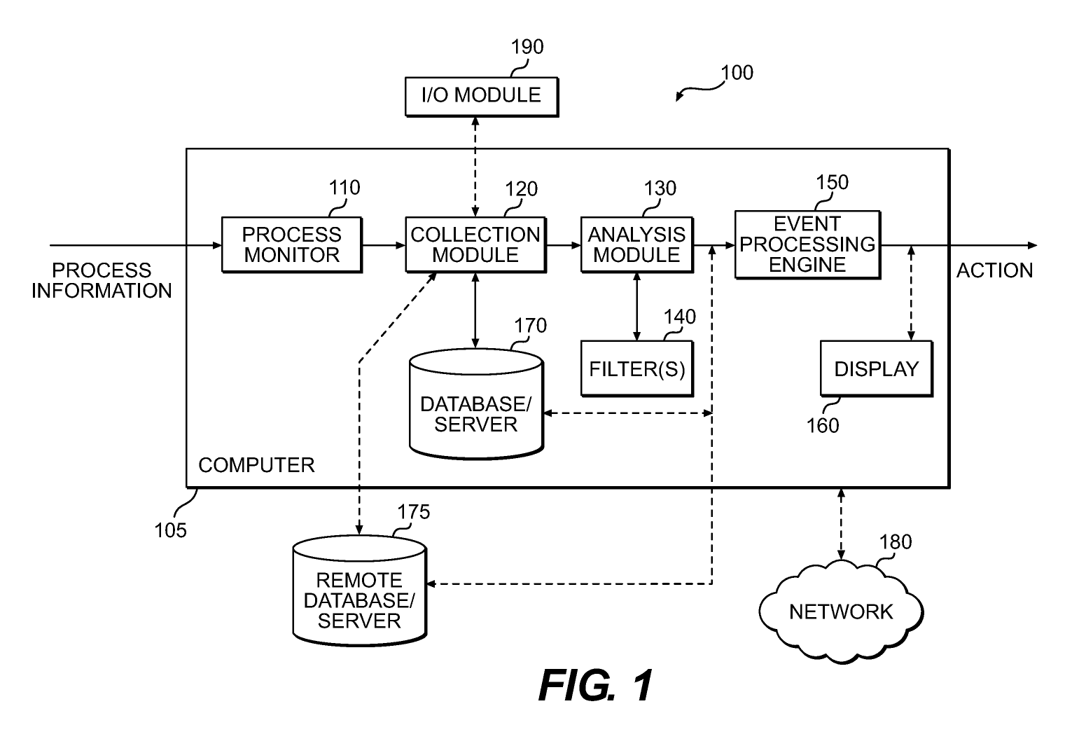

FIG. 1 illustrates an exemplary embodiment of a system 100 for computer analysis. In the embodiment of FIG. 1, system 100 is implemented using software, firmware, hardware, or a combination thereof In certain exemplary embodiments, the system 100 and methods described below are implemented in real time using software as an executable program in a non-transitory computer-readable medium executed by a special or general purpose digital computer, such as a personal computer, workstation, minicomputer, or mainframe computer, generally referred to as a computer 105. The computer 105 can be windows-based and/or use any other operating system known to those of skill in the art. The computer 105 at least partially implements the modules and elements described below with one or more computer processors, memory coupled to a memory controller, and one or more input and/or output (I/O) devices (peripherals). Examples of the input/output controller include one or more buses or other wired or wireless connections. The input/output controller may have additional elements, also omitted for simplicity, such as controllers, buffers (caches), drivers, repeaters, and receivers, to enable communications. Further, the local interface may include address, control, and/or data connections to enable appropriate communications among the aforementioned components.

The computer 105 includes at least one processor (not shown) as a hardware device for executing software stored in a non-transitory computer-readable medium. The processor can be any custom made or commercially available processor, a central processing unit (CPU), an auxiliary processor among several processors associated with computer 105, a semiconductor based microprocessor (in the form of a microchip or chip set, for example), a macroprocessor, or generally any device for executing software instructions. In certain exemplary embodiments, the memory can have a distributed architecture, where various components are situated remote from one another, but can be accessed by the system 100. The processor is configured to execute software stored within the memory, to communicate data to and from the memory, and to generally control operations of the computer 105 pursuant to the software. When the systems and methods described herein are implemented in software, the methods are stored on any non-transitory computer readable medium for use by or in connection with any computer related system or method. In the context of this document, a non-transitory computer readable medium is an electronic, magnetic, optical, or other physical device or means that can contain or store a computer program for use by or in connection with a computer related system or method. The software in the non-transitory computer-readable medium may include one or more separate programs, and may be in the form of a source program, executable program (object code), script, or any other entity comprising a set of instructions to be performed.

The system 100 optionally connects with at least one network 180. In the exemplary embodiment shown, the network 180 can be a managed IP network administered by a service provider. The network 180 may be implemented using wireless protocols and technologies, such as WiFi, WiMax, etc. The network 180 can also be a packet-switched network such as a local area network, wide area network, metropolitan area network, Internet network, or other similar type of network environment. The network 180 may be a fixed wireless network, a wireless local area network (LAN), a wireless wide area network (WAN) a personal area network (PAN), a virtual private network (VPN), intranet or other suitable network system and includes equipment for receiving and transmitting signals. The network 180 can also have a hard-wired connection to system 100.

In the exemplary embodiment of FIG. 1, a process monitor 110 receives process information and is configured to monitor at least one process in real time. In certain embodiments, process monitor 110 groups processes by what is known about them. Process information includes binary information such as manufacturer, application description and file path and database information such as recommendations, categorization, or other information regarding an identified item. In still further exemplary embodiments, processes are grouped and sorted by manufacturer or application name (all processes running associated with Adobe®, for example). In still other exemplary embodiments, process statistics are rolled into sums to display a higher level view of resource usage (showing how many Apple® programs are affecting a system, for example) and/or to allow drilling down into the details for specific programs (show the resources used by Adobe Reader®, for example). In still further exemplary embodiments, the process monitor 110 provides control over grouped processes, giving the ability to stop selected processes (Adobe Reader® processes, for example) from running. In still other exemplary embodiments, process monitor 110 correlates processes in a tree (i.e., which sub-processes go with which parent). Correlating parent-child relationship between processes helps group and control processes intelligently, and helps track a process back to a service that launched it. This also helps show how recommended changes would impact processes that are running.

The process monitor 110 operatively connects with a collection module 120 configured to collect information on the at least one monitored process. The collection module 120 tracks system information on system resource usage (such as CPU, disk, memory, and network utilization, for example) and tracks information on process activity. The collection module 120 provides processes system information for examination by an event processing engine 150 in real or near-real time. The collection module 120 optionally connects with at least one database/server 170, which can be a remote database/server 175. For example, in the embodiment of FIG. 1, information identified by the collection module 120 is flagged for analysis by an analysis module 130 if the collected information meets at least one predetermined criterion. Flagged items are stored in an event database/server and are forwarded to an analysis module 130 for further examination.

The collection module 120 optionally connects with input/output (I/O) module 190. In the exemplary embodiment of FIG. 1, I/O module 190 is implemented via a keyboard and mouse (not shown). Other exemplary I/O devices include a printer, a scanner, and/or a microphone. Although not shown for simplicity, the I/O module 190 communicate inputs and outputs from, for example, a network interface card (MC) or modulator/demodulator (for accessing other files, devices, systems, or a network), a radio frequency (RF) or other transceiver, a telephonic interface, a bridge, and/or a router.

Collection module 120 operatively connects to analysis module 130, which analyzes collected information in real time using at least one dynamic, updatable filter 140. The analysis module 130 works with filter 140 to identify at least one item matching one or more criteria to trigger an action or generate a report based upon the match. Triggers or reports (notifications) can be preset or customized, with the option to override or change a trigger or notification. In the exemplary embodiment of FIG. 1, filter 140 is configured to identify at least one triggering item or event matching at least one predetermined filter criterion, and to provide information regarding the at least one triggering item to an event processing engine 150 for examination. This at least one dynamic updatable filter 140 (also known as a script or a threshold) identifies events for the analysis module 130 to analyze. The filter 140 can be predefined, or configured to be prepared and/or updated as part of a subscription providing filter updates and additional functionality.

Examples of filter 140 criteria include process name, binary details (such as the properties of the launcher), a user who ran a process, and whether full screen mode was enabled. These criteria for filter 140 are exemplary only. Other exemplary criteria include whether a process exceeds a threshold of resource usage for a certain amount of time, one or more activity types (process started or stopped, for example), whether a specific script is triggered or causes another script to run, a time range for a detected activity, the number of filters or thresholds triggered (e.g. match multiple triggers with differing process names), and whether an item is blacklisted/whitelisted.

A white list is a list of items that are normally found but are considered acceptable. A white list may include, for example, user-approved programs or other products. Placing them on a white list excludes the listed items from being identified by a filter 140 or triggering an action or cause a report to be generated. A black list is a list of bad things that are known to cause performance issues and/or meet filter criteria. Placing these items on a black identifies them as an issue without further analysis. Typically blacklist items are things like malware, spyware, or programs known to cause performance issues. White and black lists can be updated by a user, a remote server and/or the end-user when they are determined to meet at least one white list or black criterion.

In the exemplary embodiment of FIG. 1, analyzed data is passed to the event processing engine 150. The event processing engine 150 is configured to accept information regarding the at least one triggering item and determine whether to take at least one action in real time in response to a triggering item or event. In certain exemplary embodiments, event processing engine 150 is also configured to identify resource issues. In certain exemplary embodiments, event processing engine 150 monitors for and provides alerts regarding system resource limitations. In certain embodiments, for example, event processing engine 150 monitors for whether a computer is frequently swapping as a possible indication of needing additional memory. Swapping is a term that is used in a virtual memory system like Windows®. For example, a computer may have 4GB of RAM but be running a combined application load that exceeds the physical amount of available memory. In these instances, the operating system implements memory swapping by using a hard disk (or SSD) as an extension of RAM, thus giving the computer more capability. This can cause performance issues if the computer tries to swap too much (or uses an excessive amount of memory). In these instances, the computer gets too busy with memory and becomes unresponsive.

In certain exemplary embodiments, event processing engine 150 also monitors for disk issues. In these embodiments, event processing engine 150 monitors hardware performance to look for a poorly-performing disk. A poorly performing disk can mean a number of things from hardware degradation where the drive is close to failure or a severely fragmented disk where the individual file sectors are located all over the physical disk. Software can check for these conditions. Signs that a disk is close to failure include: an increase in number of read errors above a predetermined amount, a drive temperature exceeding a given temperature range for a give period of time, and/or a change in drive speed above or below a predetermined speed.

In such an exemplary embodiment, event processing engine 150 monitors for programs that cause consistent disk usage, and makes a recommendation such as moving the program to another disk or a faster disk. In certain embodiments, event processing engine 150 recommends swapping files located on a disk that is not consistently used. In still other exemplary embodiments, event processing engine 150 monitors for CPU activity patterns and identifies where a CPU upgrade would improve performance.

In still other exemplary embodiments, event processing engine 150 monitors for slow performance, and looks for potential causes. Slow performance could be something as simple as the frame-rate of video game slowing to a point where the computer is so busy it can't animate a game, to a known application taking more than a predetermined amount of time to execute. The intent here is to give users knowledge that they are overtaxing the computer or video card and make at least one recommendation as to what part of the system can be changed, reconfigured, and/or upgraded to alleviate the problem. In the gaming scenario, for example, if a game that normally has a rate of 30 frames per second slows to a rate of, for example, 15 frames per second, the system may recommend a new graphics card or changes in system configuration, and/or adding RAM.

This feature could combine the sliding window of tracked information and scripts. In certain exemplary embodiments, if a slowdown is identified event processing engine 150 looks for heavy resource users—i.e., items responsible for causing a resource pool (a CPU, for example) to be near maximum performance. If no resource pool is approaching a maximum usage, the event processing engine 150 need not execute this function. In certain exemplary embodiments, system 100 checks whether there is at least one spike in resource usage causing a slowdown. An example of a spike in resource usage is a CPU is running at near capacity for several real seconds with no program being launched, or disk usages where there are excessive reads for a prolonged period of time with no apparent activity occurring (i.e., programs running in background that are not apparent to the user and/or causing high disk activity). An example of a user-initiated high disk activity is the activity that occurs when copying files, loading a program, or other similar activity. Another example of increasing resource usage causing a slowdown is a memory leak (i.e., when program uses more system memory the longer it is used and/or run in the background). If a spike is identified, it is highlighted.

In certain embodiments, the event processing engine 150 can also check for one or more spikes in the number of processes started or active (e.g. death by a thousand cuts). The event processing engine 150 can perform this check at a given moment in time, and/or it can perform a historical analysis to identify potential trends. For example, if multiple applications are competing to perform numerous read/write operations, these operations may not individually qualify as a triggering item or event, whereas collectively they might. In such an instance, changing the priority of a single process may not be a good solution, and could actually degrade system performance in situations when these multiple applications are not all running. Accordingly, in certain embodiments the event processing engine 150 monitors multiple events and/or the system as a whole. In these embodiments the event processing engine 150 looks at interactions between multiple processes and/or resources to identify potential problems and/or propose at least one solution to an identified problem.

In the exemplary embodiment of FIG. 1, the event processing engine 150 optionally connects with a display 160. The display 160 includes information on system performance of at least: one database, information provided by a community of users, locally stored information, and live data obtained from the Internet. In certain embodiments, display 160 is configured to display one or more of information on applications, services, and processes from a variety of sources, including updatable databases, and offers different views of process data information. Examples of displayed processes include one or more process consistently in the top users of resources on system startup. This helps facilitate a determination of whether the process or tied service is needed, and whether to recommend preventing the identified process from starting during system startup. In certain embodiments, the display 160 allows an identified process to be stopped by killing the process (end process), and in other embodiments both the process and its descendants are stopped (end process tree).

Other examples of displayed information include properties of binaries (such as manufacturer details, file paths, copyright info, application details); graphs of monitored resource data points; and graphs of live data for current resource usage. Information can also be filtered and/or displayed based on timeframes (e.g. over the lifetime of knowledge) and/or whether an item is whitelisted, blacklisted, or marked for extra tracking (e.g. flagged as poorly behaving). Something that is poorly behaving is an application, process or service that is known to degrade overall system performance or cause system instability, or is considered useless or redundant. Other information that can be displayed include the number of times an item was marked as behaving oddly (similar to an item that is poorly behaving, except that it behaves badly only under certain circumstances—e.g., iTunes® help may work great on all operating systems except Windows Vista®), the number of times an item was started, the first or last time an item was seen, and a recommendation by a user community.

In certain embodiments, the display 160 ties multiple sources together and allows a user to shift from one view to another (e.g. drilling in or out to change the view of the information). Processes can be displayed by service/application and/or by sub-processes for a selected app/service, with links to drill down and view details on each. Alternatively or in addition, services/applications are displayed by product group or by a product, and can have links for drilling down to obtain additional information on the selected item. For example, the display is configured to show what a program (Adobe Reader®, for example) is doing on a monitored computer. In still other embodiments, services/applications are displayed by manufacturer and/or group services and/or applications grouped by company. Links can be configured to drill down into details on each, showing, for example, what Microsoft® products are running on a monitored system.

In still other exemplary embodiments, display 160 includes a context-sensitive browser for viewing at least one online database of information showing items such as how many people are reporting difficulties with a process/application, the average resource usage for a process/application, process/application manufacturing details, information on what a process/application does and what would happen if it were ended, and whether a user community recommends disabling a process/application. In still further embodiments, system resource utilization is displayed in real-time in a graph showing, for example, a task manager or a process manager. Individual processes within a graph could also be highlighted, or separate graphs can be shown for specific processes. In further exemplary embodiments, display 160 includes tools that enable a user to stop a process/application from running, delay a process and/or application from running, open monitoring settings for this item, submit information about a process/application information to a user community; and tell a user community that information on a process and/or application needs updating.

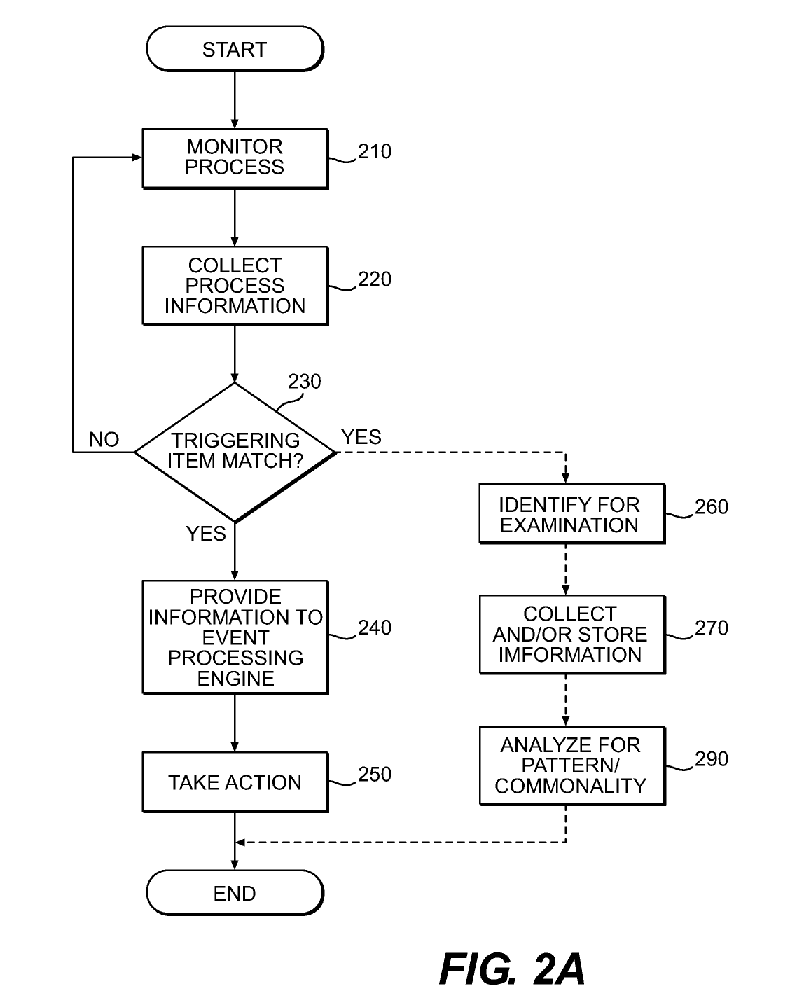

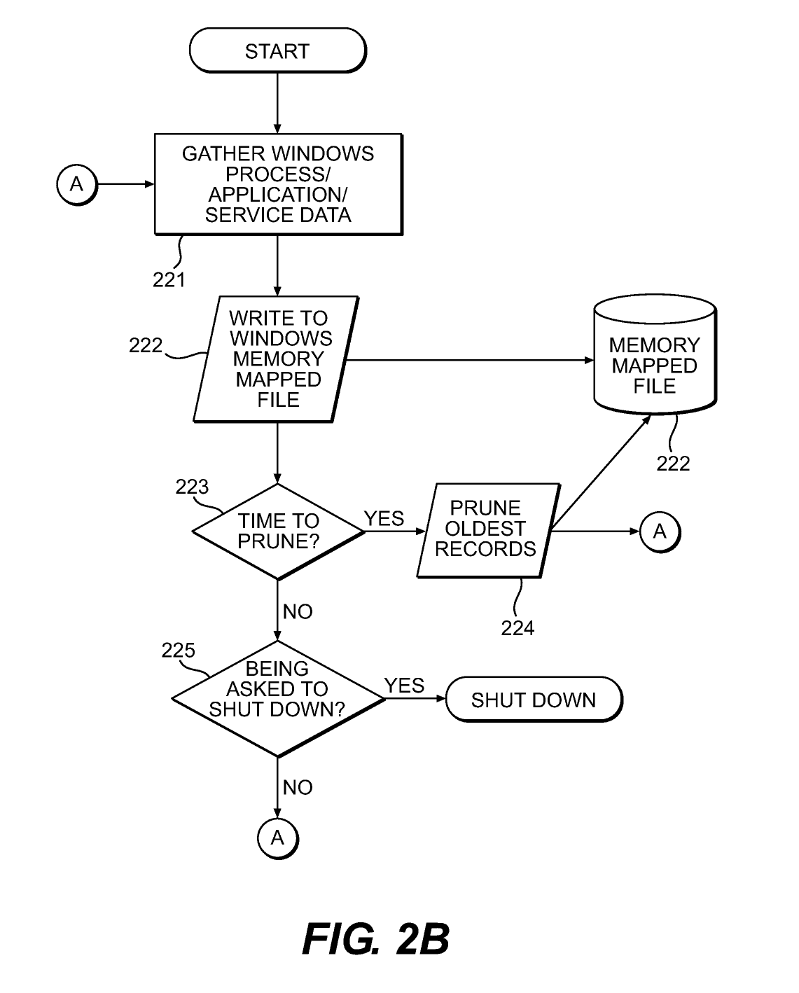

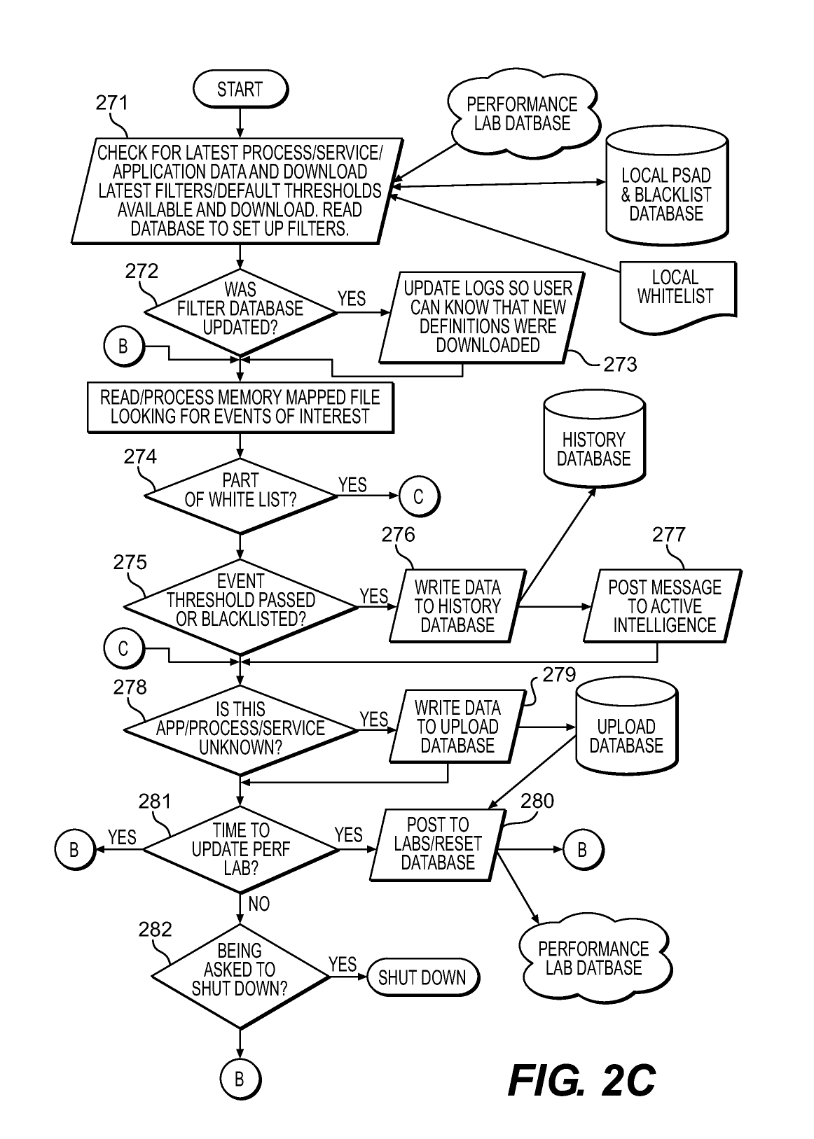

FIG. 2A illustrates an exemplary method of computer analysis. In certain embodiments, the method is implemented with a computer program product comprising non-transitory computer readable medium having stored thereon computer executable instructions that when executed causes the computer to perform the disclosed method. In the exemplary method of FIG. 2A, at least one process is monitored in real time 210, and information is collected on the at least one monitored process 220. The information is analyzed using at least one dynamic, updatable filter to identify at least one triggering item or event matching at least one predetermined filter criterion 230.

In certain embodiments, filter 140 is configured to check for at least a process name, binary details of a process launcher, a user who ran a process, and whether a full screen mode is enabled. In other exemplary embodiments, the filter 140 is configured to check for at least one or more items responsible for causing a resource pool to be near maximum usage, at least one spike in resource usage, at least one spike in a number or processes started or active, whether a computer swaps memory more than a predetermined number of times in a given time period, and whether a program causes disk usage to exceed a predetermined threshold. In still other exemplary embodiments, filter 140 is configured to check for at least one item selected from the group consisting of CPU memory usage exceeding a predetermined threshold, a difference in a number of processes running in a predetermined configuration, a process that is not running a required category, an increase in average resources used by a monitored process, a process that is running above its normal priority, and a process that is not obeying its normal scheduled behavior.

Filter 140 looks for at least one triggering event. In certain examples, the at least one triggering event is selected from the group consisting of a process exceeding a threshold of resource usage for a predetermined amount of time, a predetermined activity type starting or stopping, a first predetermined script starting, a first predetermined script causing a second predetermined script to start, and a predetermined number of activity types starting or stopping. Information regarding the at least one triggering item is provided to an event processing engine for examination 240, and at least one action is taken in real time in response to the identified triggering item or event 250.

There are a number of potential actions in response to an event. Actions could be taken automatically, or presented as options for responding to the event. Such actions include logging an alert to a report, triggering a user notification, prompting a user to take action, stopping a service and/or killing a process, lowering an item's processing priority, changing a CPU affinity for an identified process, moving a program to a different disk based on program usage, and recording a data point. Other examples of actions include triggering at least one reporting action based upon a match of at least a portion of the collected information with at least one predetermined filter criterion, displaying information to a user in response to a monitored process activity, and providing at least one recommendation in real time for improving system performance. Still other examples of actions taken include tracking system resource usage and/or process activity in real time, recording system resource usage and/or process activity in real time, and/or displaying system resource utilization in real time.

In still other exemplary embodiments, actions include adding a filter 140 for an identified process (e.g. an alert for when a process is active, for example, and/or a counter that increments when a process starts or stops), flagging an item as poorly behaving, and adding an item to a whitelist or blacklist. In certain embodiments, if an item is in a whitelisted, filter 140 is set to prevent the item from triggering certain actions. In other embodiments, if an item is in blacklisted, filter 140 could be set to trigger an action. Other examples include triggering a slider notification (i.e. a message box that slides into view); prompting a user to take action; and recording a data point.

Other steps can be added, and need not be performed in the order shown. For example, the method of FIG. 2A may also include the steps of identifying information for examination 260, collecting and/or storing the identified information 270 and analyzing the information for patterns and/or commonalities 290. In certain exemplary embodiments, the at least one item of information identified for examination is collected from a plurality of users, stored on a server and/or database, and may also be submitted for examination or sharing with a user community. Examples of collected information include the first time an item was seen, the last time an item was seen, the number of times an item was started, the number of times an item was stopped, and the number of times an item was marked as behaving oddly. The method may also include identifying a change in a number or a behavior of processes running on a monitored computer.

FIG. 2B illustrates an exemplary method of data collection and storage. In certain exemplary embodiments, saving full details of the system quickly amasses a large amount of data. Therefore, items that are tracked are monitored with full details over a certain amount of time (a five minute window, for example), and at least a portion of the data outside of this window is discarded. In exemplary embodiments where all data outside the monitored window is not discarded, maintained data points from outside the window can be maintained in the same database, or in a separate one for holding older data. In the exemplary method of FIG. 2B, system 100 gathers process, application, and service data 221 and writes this data to a memory mapped file 222. The system 100 checks to whether it is time to prune the gathered data 223. If it is (i.e., if data has been collected for the designated time window), the system discards (prunes) at least a portion of the oldest collected data 224 and writes more recent data to the memory mapped file 222. The system then checks to see if it is being asked to shut down 225. If it is, the system shuts down. If not, the process repeats.

Other steps can be added, and need not be performed in the order shown. In the method of FIG. 2C, for example, the method includes step 271 (checking for the latest process, service, and/or application data and downloads the latest filters and/or default thresholds, and reading available databases to set up at least one filter 140). In certain exemplary embodiments, at least one of the databases contains one or more XML files of data collected on identified processes. The databases are updatable, with the ability to identify and highlight updates to the underlying data. In certain embodiments, the databases contain at least the following information pertaining to the following data: a version number, a version date, and an indication of the number of items changed in an update.

The exemplary method of FIG. 2C further includes the step of checking whether a filter database was uploaded 272 and, if so, the method also includes the step of updating a log showing that filter definitions were downloaded 273. The method further includes the step of checking to see whether an item is part of a white list 274, and checking to see if an event threshold has passed and/or if an item is identified as blacklisted 275. If the answer is yes, the method further includes the step of writing the event to a database 276 and optionally posts a message regarding the identified item 277. The method further includes the step of checking to see if an application, process, or service is unknown 278. If it is unknown, in step 279 data about the unknown application, process, or service is flagged for uploading to a database. It can then be uploaded into at least one database in step 280. The method further includes the step of checking to see if it is time for an update 281. If it is, the system repeats step 273. In step 282 the system checks to see if it is being asked to shut down. If it is, the system shuts down. If not, step 273 is repeated.

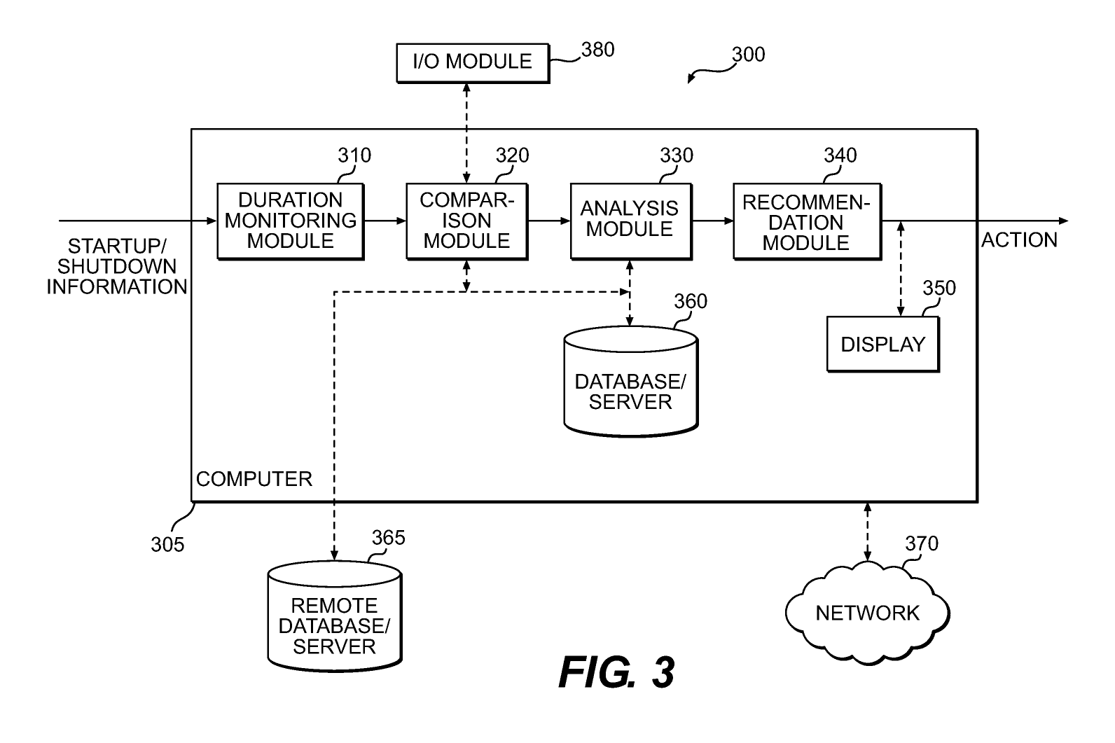

FIG. 3 illustrates an exemplary embodiment of a system for improving startup and/or shutdown. The system 300 is implemented at least in part using software, firmware, hardware, or a combination thereof. In certain exemplary embodiments, the system is implemented at least in part with software as an executable program in a non-transitory computer-readable medium executed by a special or general-purpose digital computer, such as a personal computer, workstation, minicomputer, or mainframe computer, generically referred to as a computer 305. The computer 305 can be windows-based and/or use any other operating system known to those of skill in the art. In the exemplary embodiment of FIG. 3, a duration monitoring module 310 configured to monitor the duration of a startup or shutdown receives startup and/or shutdown information. The duration monitoring module 310 operatively connects with a comparison module 320 configured to compare the duration information with a baseline startup or shutdown duration. When the comparison module 320 identifies a change in startup or shutdown duration with respect to the baseline duration, it inputs the collected information to an analysis module 330 configured for identifying at least one reason why system startup or shutdown duration changed. A change is typically an increase or a decrease in startup or shutdown duration. The analysis module 330 operatively connects with a recommendation module 340 configured to provide in real time at least one recommendation for improving the startup or shutdown duration, which optionally connects with a display 350 configured to display a reason for the change in startup or shutdown duration.

In certain exemplary embodiments, system 300 optionally connects with a network 370. The network 370 can be, for example, a managed IP network administered by a service provider. The network 370 may be implemented in a wireless fashion, e.g., using wireless protocols and technologies, such as WiFi, WiMax, etc. The network 370 can also be a packet-switched network such as a local area network, wide area network, metropolitan area network, Internet network, or other similar type of network environment. It may be a fixed wireless network, a wireless local area network (LAN), a wireless wide area network (WAN) a personal area network (PAN), a virtual private network (VPN), intranet or other suitable network system and includes equipment for receiving and transmitting signals. The network 370 can also have a hard-wired connection to system 300.

The comparison module 320 also optionally connects with at least one database/server 360, which can be a remote database/server 365. In the exemplary embodiment of FIG. 3, information identified by the comparison module 320 is flagged for analysis by the analysis module 330 if the information meets at least one predetermined criterion. Flagged items are stored in at least one event database/server 360 and/or 365 and are forwarded to analysis module 330 for further examination. In certain exemplary embodiments, comparison module 320 optionally connects with an input/output (I/O) module 380. In the exemplary embodiment of FIG. 3, the I/O module 380 is implemented via a keyboard and mouse (not shown). Other exemplary I/O devices include a printer, a scanner, and/or a microphone. Although not shown for simplicity, the I/O module 380 communicate inputs and outputs from, for example, a network interface card (NIC) or modulator/demodulator (for accessing other files, devices, systems, or a network), a radio frequency (RF) or other transceiver, a telephonic interface, a bridge, and/or a router.

The comparison module 320 operatively connects with analysis module 330. In this exemplary embodiment, the analysis module 330 intelligently groups and/or sorts data (e.g., grouping and/or sorting processes, applications or services by the amount of CPU, memory or disk operations used). The analysis module 330 analyzes the data for potential reasons why system startup or shutdown duration is increasing. In certain exemplary embodiments, the analysis module 330 determines when a machine has finished booting, and records a time to reach this state. Typical startup events include Microsoft® service host process, Windows® login user interface, and local security authentication. For system shutdown, the analysis module 330 records the duration until the last trackable event prior to shutdown. A last trackable event is the last event before the desktop appears on startup or disappears on shutdown. Using this information, the analysis module 330 compiles statistics on average startup and/or shutdown duration, and determines when the averages trend upwards. In certain embodiments, analysis module 330 also checks whether startup and/or shutdown duration is within a recommended time limit.

In other exemplary embodiments, analysis module 330 identifies areas potentially needing fixing by looking for differences such as a difference in the number of processes running, or the number of running processes that are not in a certain category. Other exemplary items the analysis module 330 looks for include an increase in the average resources used by a monitored process, and/or a resource-specific problem (such as, for example, a disk having an increasing input/output but a slower performance, or a memory usage that is approaching maximum availability). The analysis module 330 also optionally identifies processes that are running above a normal priority, and/or identifies processes that are not obeying a normal scheduled behavior (for example, not stopping when directed to or not giving back control when directed).

In still other exemplary embodiments, the analysis module 330 compares current disk utilization against previously measured and/or pre-determined performance statistics. In still other exemplary embodiments, analysis module 330 compares general system statistics against at least one data point. For example if startup or shutdown duration changes beyond a certain threshold, the analysis module 330 compares the current configuration with a previous configuration and identifies any differences. In certain other embodiments, the analysis module 330 groups common or simplified actions next to processes, for analysis or presentation in a simplified display of the processes involved in system startup and shutdown. Examples of simplified actions include raising the priority of a process, lowering the priority of a process, killing a process, or removing a process from startup and/or shutdown.

In the exemplary embodiment of FIG. 3, analysis module 330 operatively connects with recommendation module 340. Recommendation module 340 makes recommendations based on input from the analysis module 330. These recommendations can be implemented automatically, manually, or some combination of the two. Actions include creating a tool that removes non-recommended startup items from the list of items that automatically launch on startup, for example, or automatically defragmenting commonly run application folders. In other embodiments, the recommendation module 340 includes an automatic improvement mode feature that makes a change and tests to see if the startup and/or shutdown averages are improved as a result of the change. In certain embodiments, recommendation module 340 implements changes over time by implementing changes during user-initiated reboots. Over time, this feature automatically changes the system configuration to optimize startup and/or shutdown performance. In certain embodiments, the recommendation module 340 optionally includes a “run the improvement” test mode, which is a variation of this feature that makes system changes, and initiates reboots until either: a) a user stops the process, b) the recommendation module 340 determines that the implemented change is not improving startup and/or shutdown duration, or c) the recommendation module 340 does not find anything it recommends changing. In other embodiments, recommendations are provided using information from one or more databases. The recommendation module 340 can also present articles and tips from a user community, and can reserve a portion of an interface for a display of helpful information related to improving startup and shutdown.

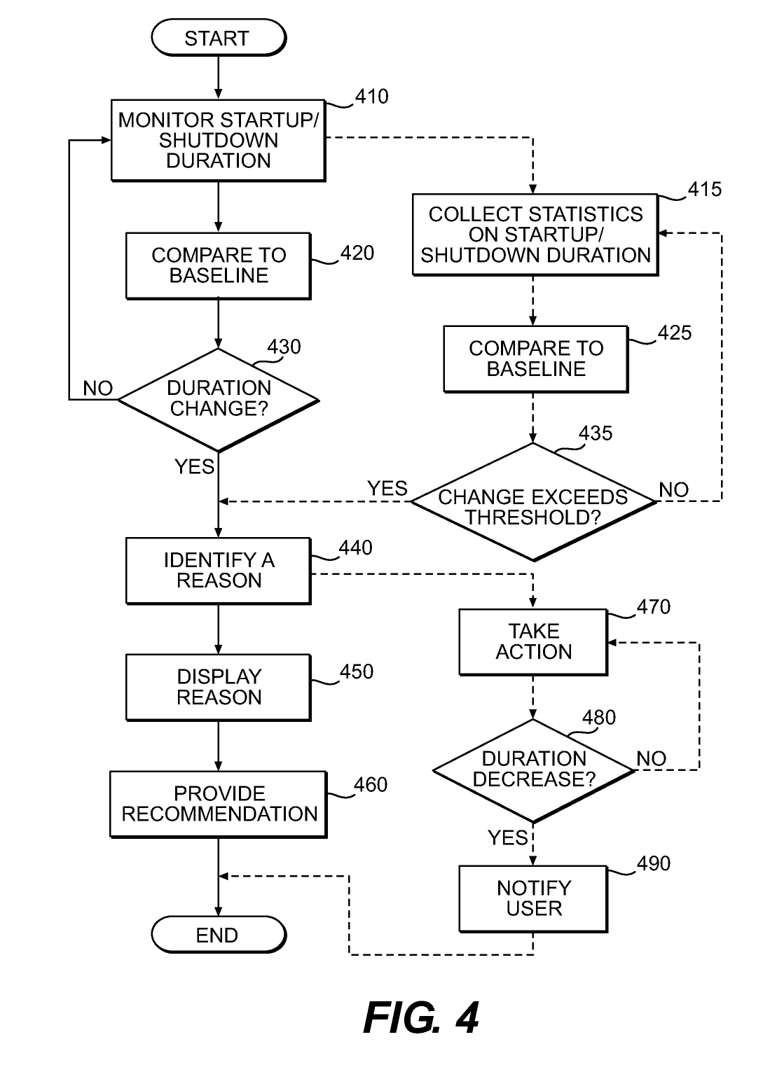

FIG. 4 illustrates an exemplary method for startup and/or shutdown improvement. The method of FIG. 4 includes the step of monitoring a startup or shutdown duration 410 and comparing the monitored duration to a baseline 420. In step 430 it is determined if the duration has changed above the baseline and, if so, a reason for the changed duration is identified in step 440. Step 440 optionally includes at least one action such as identifying a number of processes starting or stopping during startup or shutdown, identifying a change in a number or behavior of processes running on startup or shutdown, identifying a time at which CPU utilization was at a maximum, comparing a current disk utilization to at least one previously measured performance statistic, and calculating an average CPU utilization.

In step 450, at least one reason for the change is displayed. Examples of items that could be displayed include a change in average boot time (including over different timeframes such as last year, last month, last week, last boot), a change in the total number of processes (running, started, or ended), statistics on resource-specific changes such as average CPU utilization, and a change in the amount of time for which CPU usage was at maximum. In still other embodiments, step 450 optionally includes displaying information on performance improvements implemented such as, for example, the number of processes eliminated and/or the number of seconds saved per resource. In still other embodiments, step 450 includes displaying a reason in an intelligent grouping (in a graph that includes a possible application or parent service causing a duration increase, for example), or by presenting the reason in a user-friendly display of past and/or present processes. Finally, in step 460 a recommendation for improving startup or shutdown duration is provided.

Other steps can be added, and need not be performed in the order shown. For example, the method of FIG. 4 may further include the steps of collecting statistics on previous startup or shutdown durations 415, comparing the collected statistics to the baseline startup or shutdown duration 425, and identifying when the startup or shutdown duration changes beyond a predetermined amount of the baseline duration 435. If the duration has not changed beyond a predetermined duration, steps 415 and 425 may be repeated. If the duration has changed beyond a predetermined threshold, step 440 is performed. Still other exemplary methods include the step of taking an action to improve startup or shutdown duration 470 (for example by changing at least one system parameter in real time), testing to see if startup or shutdown duration decreases 480, and providing notification of the result 490. Although not shown in the method of FIG. 4, other exemplary methods can include the step of storing the collected information on a database and/or server.

### CONCLUSION

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A computer-based method of monitoring processes, comprising the steps of:
monitoring at least one process in real time;
collecting information on the at least one monitored process;
analyzing the collected information in real time using at least one dynamic, updatable filter;
identifying at least one triggering item or event matching at least one predetermined filter criterion;
providing information regarding the at least one triggering item to an event processing engine for examination; and
taking at least one action in real time in response to the identified triggering item or event.

2. The method of claim 1, wherein the at least one action is selected from the group consisting of:
triggering at least one reporting action based upon a match of at least a portion of the collected information with at least one predetermined filter criterion,
displaying information in response to a monitored process activity, and
providing in real time at least one recommendation for improving system performance.

3. The method of claim 1, wherein the at least one triggering event is selected from the group consisting of:
a process exceeding a threshold of resource usage for a predetermined amount of time,
a predetermined activity type starting or stopping,
a first predetermined script starting,
a first predetermined script causing a second predetermined script to start, and
a predetermined number of activity types starting or stopping.

4. The method of claim 1, wherein at least one recommended action is selected from the group consisting of:
logging an alert to report,
triggering a user notification,
prompting a user to take action,
lowering an item's processing priority,
changing a CPU affinity for an identified process,
moving a program to a different disk based on program usage, and
recording a data point.

5. The method of claim 1, wherein the at least one dynamic updatable filter is configured to check for at least one item selected from the group consisting of:
a process name,
binary details of a process launcher,
a user who ran a process, and
whether a full screen mode is enabled.

6. The method of claim 1, wherein the at least one dynamic updatable filter is configured to check for at least one item selected from the group consisting of:
one or more items responsible for causing a resource pool to be near maximum usage,
at least one spike in resource usage,
at least one spike in a number or processes started or active,
whether a computer swaps memory more than a predetermined number of times in a given time period, and
whether a program causes disk usage to exceed a predetermined threshold.

7. The method of claim 1, wherein the at least one dynamic updatable filter is configured to check for at least one item selected from the group consisting of:
CPU memory usage exceeding a predetermined threshold,
a difference in a number of processes running in a predetermined configuration,
a process that is not running a required category,
an increase in average resources used by a monitored process,
a process that is running above its normal priority, and
a process that is not obeying its normal scheduled behavior.

8. The method of claim 1, further comprising the step of identifying a change in a number or a behavior of processes running on a monitored computer.

9. The method of claim 1, further comprising the step of identifying at least one item for examination.

10. The method of claim 9, further comprising the steps of
collecting the identified at least one item for examination from a plurality of users,
storing the collected information on a remote server/database, and
analyzing the collected information to look for a pattern or commonality in the collected information.

11. The method of claim 9, further comprising the step of storing at least one piece of information about the at least one identified item, wherein the at least one piece of information selected from the group consisting of:
a first time the item was seen,
a last time the item was seen,
a number of times the item was started,
a number of times the item was stopped, and
a number of times the item was marked as behaving oddly.

12. The method of claim 9, further comprising the step of tracking system resource usage and/or process activity in real time.

13. The method of claim 9, further comprising the step of recording system resource usage and/or process activity in real time.

14. The method of claim 9, further comprising the step of displaying system resource utilization in real time.

15. The method of claim 9, further comprising the step of identifying one or more items of interest to maintain in a database.

16. The method of claim 9, further comprising the step of identifying an item for sharing with a community of users.

17. The method of claim 9, further comprising the step of adding an identified item to a Blacklist.

18. A computer program product comprising
a non-transitory computer readable medium having stored thereon computer executable instructions that when executed causes the computer to perform a method of monitoring processes, the method comprising the steps of:
monitoring at least one process in real time;
collecting information on the at least one monitored process;
analyzing collected data in real time using at least one dynamic, updatable filter;
identifying at least one triggering item or event matching at least one predetermined filter criterion;
providing information regarding the at least one triggering item to an event processing engine for examination; and
taking at least one action in real time in response to the identified triggering item or event.

19. A method of improving system startup or shutdown performance, comprising the steps of:
monitoring a startup or shutdown duration and comparing it to a baseline startup or shutdown duration;
identifying a change in startup or shutdown duration with respect to the baseline duration;
identifying at least one reason why system startup or shutdown duration changed;
displaying the at least one reason for the change in startup or shutdown duration; and
providing in real time at least one recommendation for improving the startup or shutdown duration.

20. The method of claim 19, wherein the step of identifying at least one reason for a change in startup or shutdown duration further includes at least one action selected from the group consisting of:
identifying a number of processes starting or stopping during startup or shutdown,
identifying a change in a number or behavior of processes running on startup or shutdown,
identifying a time at which CPU utilization was at a maximum,
comparing a current disk utilization to at least one previously measured performance statistic, and
calculating an average CPU utilization.

21. The method of claim 19, further comprising the steps of:
automatically changing at least one system parameter in real time; and
testing to see if startup or shutdown duration decreases.

22. The method of claim 19, further comprising the steps of:
collecting statistics on previous startup or shutdown durations;
comparing the collected statistics to the baseline startup or shutdown duration; and
identifying when the startup or shutdown duration changes beyond a predetermined amount of the baseline duration.

23. The method of claim 19, further comprising the step of storing the collected information on the system the information was collected from.

24. The method of claim 19, further comprising the step of storing the collected information on a remote server.

25. A computer program product comprising
a non-transitory computer readable medium having stored thereon computer executable instructions that when executed causes the computer to perform a method of improving system startup or shutdown performance, the method comprising the steps of:
monitoring a startup or shutdown duration and comparing it to a baseline startup or shutdown duration;
identifying a change in startup or shutdown duration with respect to the baseline duration;
identifying at least one reason why system startup or shutdown duration changed;
displaying the at least one reason for the change in startup or shutdown duration; and
providing in real time at least one recommendation for improving the startup or shutdown duration.
